(19) United States
(12) Patent Application Publication
(10) Pub. No.: US 2004/0006919 A1
(43) Pub. Date: Jan. 15, 2004

(54) Revolving door for placement in a facade of a building

(76) Inventor: Paul Joseph Wild, Sandy, UT (US)

Correspondence Address: PEACOCK MYERS AND ADAMS P C, P O BOX 26927, ALBUQUERQUE, NM, 871256927

(21) Appl. No.: 10/446,289

(22) Filed: May 22, 2003

Related U.S. Application Data
(63) Continuation of application No. PCT/NL01/00855, filed on Nov. 23, 2001.

(30) Foreign Application Priority Data
Nov. 24, 2000 (NL) 1016700

(51) Int. Cl. E05D 15/02

(52) U.S. Cl. 49/42

(57) ABSTRACT

A revolving door for placement in a facade of a building to provide an entrance and exit to the building, comprising a rotation axis and door leaves mounted on the rotation axis, placed between cylinder segment-like shell elements, wherein the shell elements comprise at least one movable wall segment. The movable wall segment either blocks or gives way to an area between the entrance and the exit.

The invention relates to a revolving door for placement in a facade of a building to provide an entrance and exit to the building, comprising a rotation axis and door leaves mounted on the rotation axis, placed between cylinder segment-like shell elements.

Such a revolving door has been manufactured and marketed by applicants for decades. For some applications the shell elements also comprise one or more than one moveable wall segments, as disclosed in, for example, GB-A-2,052,612 and NL-A-9302235.

When used for security purposes, the known revolving door is often provided with a card reader in order to only allow authorized persons to enter or leave the building via the revolving door. It is also known to further complete the revolving door with sensor means, which serve in particular to ensure that not more than one person at a time can pass through the revolving door. A further known embodiment of the revolving door is provided with a weapon detection system.

At an attempt by an unauthorized person to pass through the revolving door or in the event that the person carries a weapon, the known revolving door will react with various possible interventions. A first possibility is that the rotation of the door leaves is blocked so that passage through the revolving door is no longer possible in any way. An alternative embodiment that is known from the prior art also comprises a sliding door at the inside of the building, which is activated in such a situation so that although the door leaves are still able to rotate, they effectively prevent entry into the building. Such a sliding door may also be provided at the outside of the building so that an effective obstruction to exiting the building may be realized in this way.

A revolving door suitable for placement in a facade of a building to provide an entrance and exit to the building, comprising a rotation axis and door leaves mounted on the rotation axis, placed between cylinder segment-like shell elements, wherein the shell elements comprise at least one movable wall segment that either blocks or affords admittance to an area between the entrance and the exit, is known from GB-A-1,223,699. This known revolving door is particularly intended for application in airports when two or more moving streams of people must cross each other without intermingling.

The object of the invention is to improve the known revolving door such that when placed to provide an entrance and exit to a building, an unauthorized person wishing to enter or to leave the building, or a person carrying undesirable objects, may be examined more closely by personnel authorized to do so.

To this end the revolving door according to the invention is characterized in that it is provided with a sensor system for the control of the moveable wall segment. In this way the respective person may be accompanied to the area between entrance and exit where further examinations may take place.

In order to meet the above mentioned requirements effectively, it is desirable that rotation of the door leaves is allowed or refused, respectively depending on said sensor system. In this way the respective person is obliged, if the occasion arises, to actually enter the area where the examination can take place.

If the above mentioned examination is not necessary and the person may enter or leave the building, the entry to the area between the entrance and exit is blocked. In the other case, if the person or the objects the person is carrying have to be subjected to further investigation, the wall segment will allow admittance into the area intended for this purpose while blocking the door leaves. If necessary, this area may be embodied with extensive security measures. It is also possible that the security personnel remains absent from the area, and that the person who has walked in is detained until the police authorities have arrived.

The proper working of the revolving door according to the invention will benefit by the sensor system having a first sensor placed inside the building or in the revolving door for detecting objects or the like, that are unauthorized to move to the exit of the building.

It is also desirable for the sensor system to comprise a second sensor outside the building for detecting undesirable objects or the like, in particular weapons, moving to the entrance building. The revolving door according to the invention makes it possible to differentiate in a simple manner between unauthorized persons wishing to leave the building and unauthorized persons wishing to enter the building.

To this end it is only required that there are two oppositely positioned cylinder segment-like wall elements, that each wall element comprises a moveable wall segment defining a first or second area, respectively, that after the respective wall segment has given way, the first area can only be entered from inside the building, and that after the respective wall segment has given way, the second area can only be entered from outside the building.

The invention also relates to a method for operating a revolving door comprising a rotation axis and door leaves mounted on the rotation axis, placed between cylinder segment-like wall elements, which comprise at least one movable wall segment, and which is characterized in that in a first position of the at least one wall segment the shell elements form a closed front along which the door leaves can be moved to provide a passage between an entrance and an exit of the revolving door, and in that in a second position of the at least one wall segment the closed front of the shell elements is interrupted to afford admittance to an area between the entrance and the exit of the revolving door, while simultaneously rotation of the door leaves is interrupted in order to block the passage between the entrance and the exit of the revolving door.

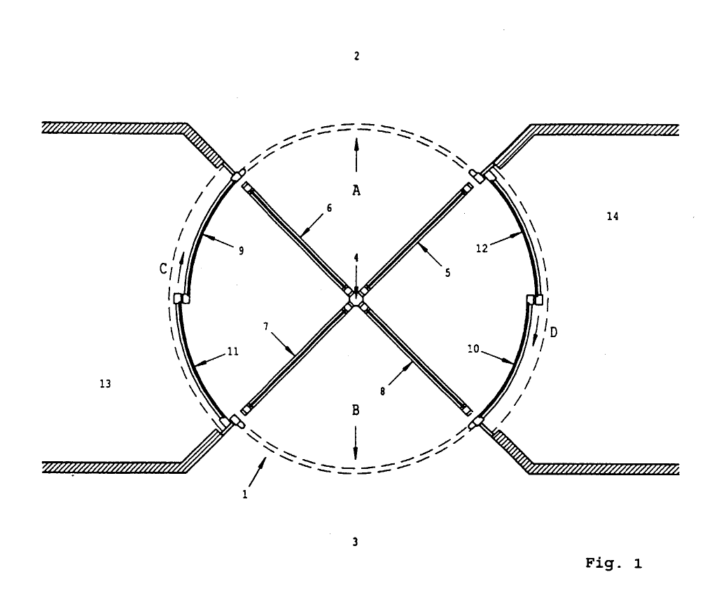

The invention will now be elucidated with reference to the drawing, in which FIGS. 1 to 5 show in horizontal cross section and in top view the revolving door according to the invention.

Identical reference numbers used in the figures always refer to similar parts.

Referring first to FIG. 1, the various parts of the revolving door according to the invention are elucidated.

This revolving door 1 is placed in the facade of a building having an inside 2 and an outside 3. The revolving door 1 is provided with a rotation axis 4 mounted on which are door leaves 5 to 8. The rotation axis 4 and the door leaves 5 mounted thereon are placed between cylinder segment-like shell elements 9 and 10. In this way the revolving door 1 provides the building with an entrance A and an exit B, respectively.

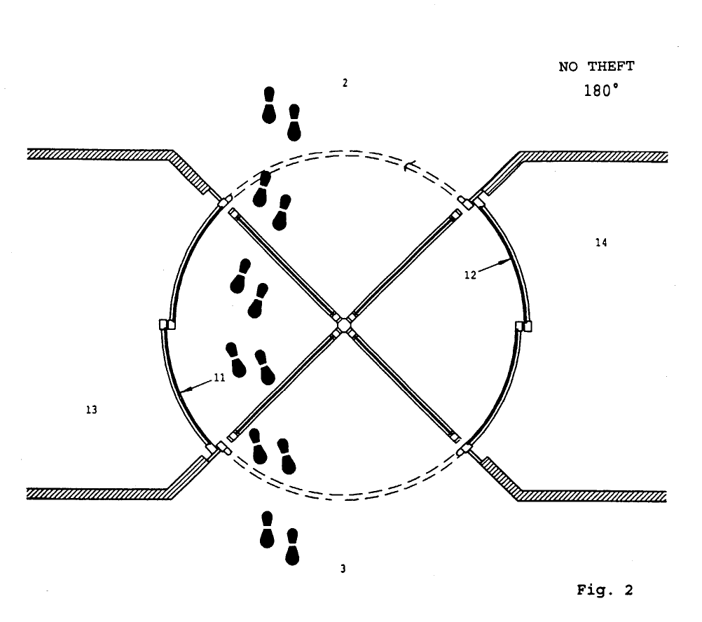

The invention also relates to the embodiment of the shell elements 9, 10, such that there is at least one movable wall segment 11, 12. FIG. 1 shows two such wall segments. The first wall segment 11 is part of shell element 9, while the second wall segment 12 is part of the shell element 10. As is further clearly shown in the Figure, after being moved in the direction of arrow C, wall segment 11 affords admittance to a first area 13, and after being moved in the direction of arrow D, the second wall segment 12 affords admittance to a second area 14. The use of the revolving door 1 according to the invention is now concisely illustrated with reference to the FIGS. 2 to 5.

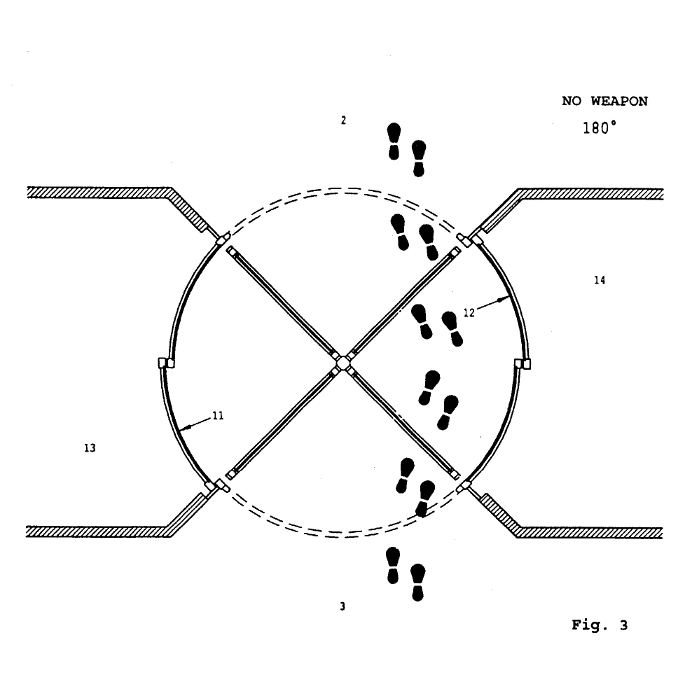

FIG. 2 shows that a person leaves the building from the inside 2 to the outside 3 and that the wall segments 11 and 12 block the admittance to the first area 13 and second area 14. Such a use of the revolving door according to the invention corresponds with the use possible with the revolving door according to the prior art. Similarly, FIG. 3 shows a person passing from outside 3 of the building to inside 2 of the building. In this situation also, where the person is authorized and does not carry undesirable objects, the movable wall segments 11 and 12 remain closed so that admittance to the first area 13 and second area 14 is blocked.

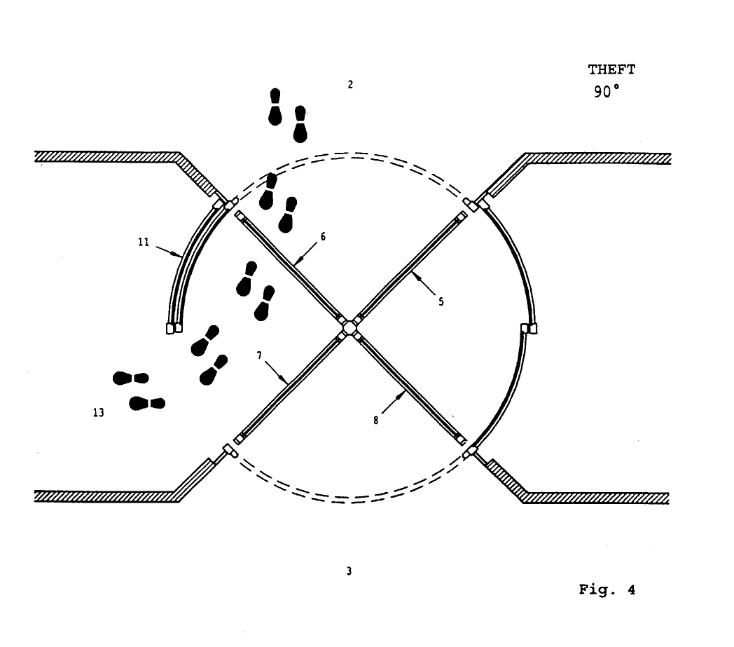

The use of the revolving door 1 as made possible by the invention is first illustrated in FIG. 4. In the situation shown in this figure, a person wishing to leave the building is carrying, for example, a stolen object, or at least an object that was established by a sensor system (not shown) not to be allowed to leave the building. In that situation wall segment 11 is activated, causing the same to be moved and admitting entrance to the first area 13. Simultaneously, also subject to said sensor system the further rotation of the door leaves 5, 6, 7, 8 blocks, thereby rendering passage from inside 2 of the building to outside 3 of the building impossible. After the person has entered the first area 13, the movable wall segment may optionally return to the original position in order to lock the first area 13, and the door leaves 5, 6, 7, 8 may be cleared for further rotation. Further investigation regarding the respective person may then take place in the first area 13.

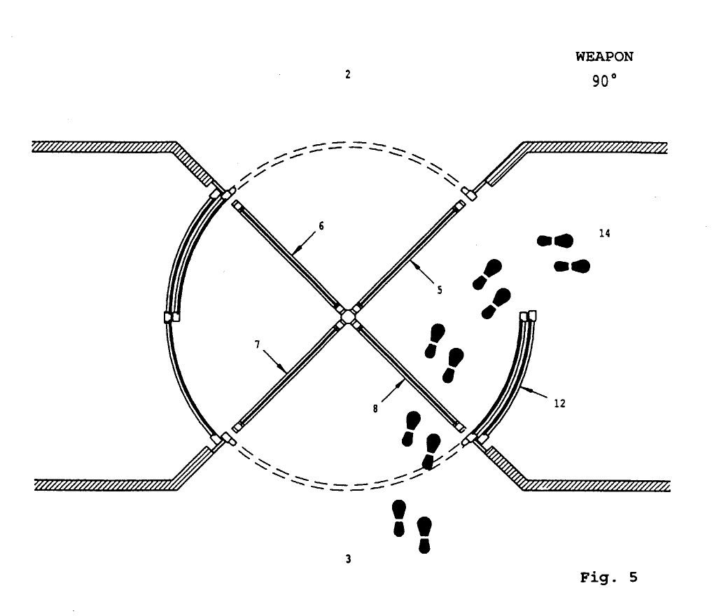

FIG. 5 shows the case where a person whishes to go from the outside 3 of the building to the inside 2 of the building while carrying, for example, a weapon. When the sensor system (not shown) detects this, it emits a signal with the result that the movable wall segment 12 is moved to the position shown, admitting entrance to the second area 14. Simultaneously, the signal from the sensor system referred to blocks the rotation of the door leaves, 5, 6, 7, 8, making admittance to the inside 2 of the building impossible and only allowing the person to enter the second area 14. After the same has arrived in the second area 14, the movable wall segment 12 may be returned to its original position, and rotation of the door leaves 5, 6, 7, 8 is cleared so that the revolving door 1 is available again for general use.

What is claimed is:

1. A revolving door for placement in a facade of a building to provide an entrance and exit to the building, comprising a rotation axis and door leaves mounted on the rotation axis placed between cylinder segment-like shell elements, wherein the shell elements comprise at least one movable wall segment that either blocks or affords admittance to an area between the entrance and the exit, wherein the same is provided with a sensor system for control of the movable wall segment.

2. A revolving door according to claim 1, wherein the rotation of the door leaves is allowed or refused, respectively, depending on the sensor system.

3. A revolving door according to claim 2, wherein the sensor system has a first sensor placed inside the building or in the revolving door for detecting objects that are unauthorized to move to the exit of the building.

4. A revolving door according to claim 2, wherein the sensor system has a second sensor placed outside the building or in a revolving door for detecting undesirable objects or weapons moving toward the entrance of the building.

5. A revolving door according to claim 1, wherein two cylinder segment-like shell elements are oppositely positioned, such that each shell element comprises a moveable wall segment defining a first and second area, such that after the respective wall segment has given way, the first area can only be entered from inside the building, and that after the respective wall segment has given way, the second area can only be entered from outside the building.

6. A method for operating a revolving door comprising a rotation axis and door leaves mounted on the rotation axis and placed between cylinder segment-like shell elements, which comprise at least one movable wall segment, wherein in a first position of the at least one wall segment the shell elements form a closed front along which the door leaves can be moved to provide a passage between an entrance and an exit of the revolving door and wherein a second position of the at least one wall segment, the closed front of the shell elements is interrupted to afford admittance to an area between the entrance and the exit of the revolving door, while simultaneously rotation of the door leaves is interrupted in order to block the passage between the entrance and the exit of the revolving door.
